(19) United States
(12) Patent Application Publication
(10) Pub. No.: US 2014/0211235 A1
(43) Pub. Date: Jul. 31, 2014

(54) Printing Control Device, Printing Control Method, And Printing System

(71) Applicant: Seiko Epson Corporation, Tokyo (JP)

(72) Inventors: Takaaki Taniguchi, Nagano-ken (JP); Takayuki Yamamoto, Nagano-ken (JP)

(73) Assignee: Seiko Epson Corporation, Tokyo (JP)

(21) Appl. No.: 14/137,311

(22) Filed: Dec. 20, 2013

(30) Foreign Application Priority Data
Jan. 30, 2013 (JP) 2013-015663

(51) Int. Cl. G06K 15/00; G06K 15/02

(52) U.S. Cl. CPC G06K 15/406; G06K 15/1805
USPC 358/1.14; 358/1.15

(57) ABSTRACT

A printing control device that sends print data to a printer can automatically configure the driver corresponding to the printer, and enables using a single printer driver to drive printers of the same model. A printing control device that sends print data to and controls printing by a printer includes: a storage unit that stores settings information for generating the print data; a configuration unit that acquires information set in the printer at a specific time, and stores the acquired information as the settings information in the storage unit; and a generating unit that generates the print data based on the settings information stored in the storage unit when printing by the printer is requested.

This application claims priority under 35 U.S.C. §119 to Japanese Patent Application No. 2013-015663 filed on Jan. 30, 2013, the entire disclosure of which is expressly incorporated by reference herein.

### BACKGROUND

1. Technical Field

The present invention relates to a printing control device that sends print data to a printer, and relates more particularly to a printing control device that can automatically configure a printer driver compatible with a particular printer, and can use a single a single printer driver for different printers of the same model.

2. Related Art

Business printers, including receipt printers for POS systems, are used in many different places in countries around the world. A driver for a particular printer is normally installed on the POS terminal or other host device, the driver (printer driver) generates and sends print data to the printer, and the printer then completes the printing process.

The print data must be generated in the font corresponding to the language and the resolution used when printing, parameter settings identifying these conditions are stored by the host, and the printer driver references these settings to execute the print data generation process.

Because the conditions of the printing process, including font information, and therefore these parameter settings, differ for printers of the same model depending upon the country and where the printer is installed, printer drivers are conventionally configured to match a particular printer installation. More specifically, multiple printer drivers that are customized in different ways may be available for the same model of printer.

JP-A-2008-77228 describes related technology that enables intuitively selecting a particular printer icon when plural printer drivers are installed in a computer, and discloses installing an appropriate printer driver for each printer.

JP-A-2002-14786 teaches a printer driver that enables changing the printer name according to the language used and enables the user to set the desired printer name, and discloses parameter settings being set according to a configuration file when the printer driver is installed. These parameter settings include the character size.

However, having multiple printer drivers for printers of the same model is undesirable because driver and printer management is more complicated and errors can easily occur when selecting a printer driver. In addition, when the parameter settings can be changed on the printer side and the settings then differ on the printer and the host, the printer driver settings must be changed so that the settings are the same on the printer and host, special knowledge maybe needed to configure the printer driver, and configuration is therefore not simple.

### SUMMARY

A printing control device according to the present invention that sends print data to a printer can automatically configure the driver corresponding to the printer, and enables using a single driver for printers of the same model.

On aspect of the invention is a printing control device that sends print data to and controls printing by a printer, and has a storage unit that stores settings information for generating the print data; a configuration unit that acquires information set in the printer at a specific time, and stores the acquired information as the settings information in the storage unit; and a generating unit that generates the print data based on the settings information stored in the storage unit when printing by the printer is requested.

In another aspect of the invention, the specific time is when the printer power turning on is detected.

In another aspect of the invention, the specific time is when printing by the printer is requested.

Further preferably in another aspect of the invention, the settings information includes at least font information.

Further preferably in another aspect of the invention, a default value of the settings information is stored in the storage unit.

Another aspect of the invention is a printing control method of a host device that sends print data to and controls printing by a printer, wherein settings information for generating the print data is stored in the host device, and the control method includes steps of acquiring information set in the printer at a specific time, and storing the acquired information as the settings information; and generating the print data based on the stored settings information when printing by the printer is requested.

Another aspect of the invention is a printing system including a printer and a printing control device that sends print data to and controls printing by the printer. The printing control device includes a storage unit that stores settings information for generating the print data, a configuration unit that acquires information set in the printer at a specific time, and stores the acquired information as the settings information in the storage unit, and a generating unit that generates the print data based on the settings information stored in the storage unit when printing by the printer is requested. The printer returns the settings information stored in the printer in response to a command requesting the settings information from the printing control device, and prints according to the print data generated by the generating unit of the printing control device based on the settings information.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a function block diagram of a printing control device according to a preferred embodiment of the invention.

FIG. 2 is a flow chart showing an example of the control process.

### DESCRIPTION OF EMBODIMENTS

A preferred embodiment of the present invention is described below with reference to the accompanying figures. The technical scope of the invention is obviously not limited to the embodiment described below. Note also that like or identical parts are identified by the same reference numerals in the accompanying figures.

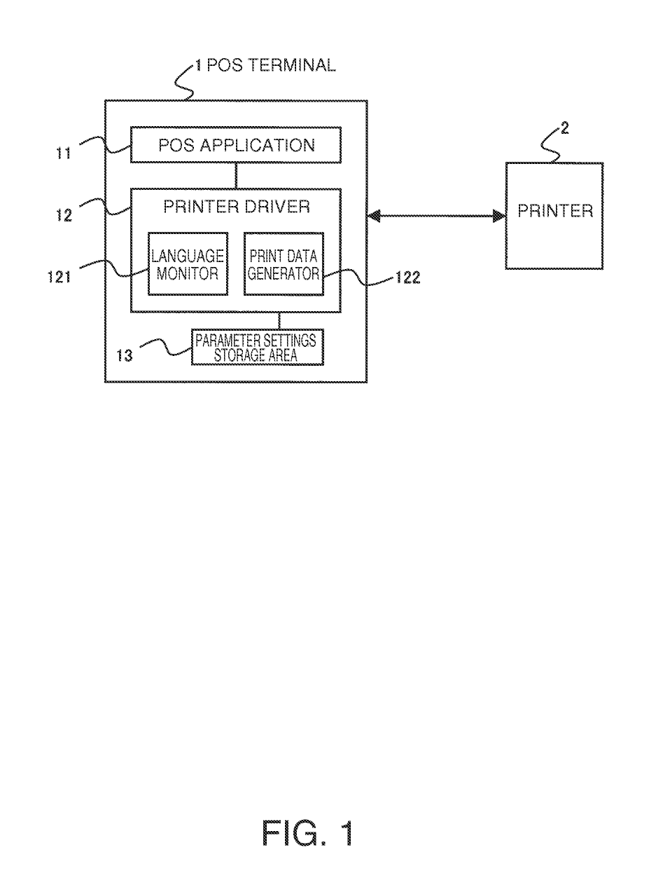

FIG. 1 is a function block diagram of a printing control device according to a preferred embodiment of the invention. The POS terminal 1 shown in FIG. 1 is a printing control device according to the invention. When the printer 2 power turns on, for example, the POS terminal 1 gets the parameter settings of the printer 2, executes a process that stores the settings as the parameter settings of the driver in a specific storage area, automatically correlates printer and driver settings, and enables controlling different printers of the same model with a single printer driver.

The embodiment shown in FIG. 1 anticipates using the invention in a POS system. A POS system has a printer 2 for printing receipts, for example, connected to a POS terminal 1 that functions as an electronic cash register at a checkout counter in a store, for example.

The POS terminal 1 is a terminal device (computer) that executes a transaction process based on input sales information, and issues receipts. While not shown in the figure, the P OS terminal 1 includes a CPU, RAM, hard disk drive, input device, display device, and communication interface, and operates as a host device relative to the printer 2.

Functionally, the P OS terminal 1 includes a P OS application 11, a printer driver 12, and a parameter settings storage area 13 (storage unit) as shown in FIG. 1.

The POS application 11 is the part that runs the transaction process, and requests printing a receipt. The POS application 11 includes a program that controls these processes, a CPU that executes processes according to the program, RAM in which the program is loaded, and a hard disk drive where the program is stored.

The printer driver 12 is the part (including hardware and software in this example) that handles the driver functions for the printer 2, receives print requests for the printer 2, generates print data, sends the print data to the printer 2, and instructs printing. Functionally, the printer driver 12 includes a language monitor 121 (setting unit) and a print data generator 122 (generating unit). Though not shown in the figure, the printer driver 12 also includes a part that provides an interface for the user to set the printing conditions.

The language monitor 121 serves the function of a print manager that receives status data and other information from a printer capable of bidirectional communication, and is also called a bidirectional communication module. The language monitor 121 executes a process that acquires the parameter settings of the printer 2 and updates the parameter settings used by the print data generator 122, and this process is a major feature of the POS terminal 1. Note that the parameter settings are the values of the parameters that determine the content of the printing process, including the printing conditions of the printer 2, and include what font is used (device font), the print resolution, and such information as the compression method used for data transmission.

The print data generator 122 generates the print data that is sent to the printer 2, and executes the generation process based on the parameter settings stored in the parameter settings storage area 13. The print data is generated using commands compatible with the printer 2, and includes control commands and data about the images to be printed. Because this print data controls the content of the printing process performed by the printer 2, generating this data requires the correct parameter settings, that is, the settings in the printer 2.

The language monitor 121 and print data generator 122 include the programs controlling the processes executed thereby, a CPU that runs the processes according to the programs, RAM in which the programs are loaded, and a hard disk drive or other medium that stores the programs.

The parameter settings storage area 13 stores the parameter settings used by the printer driver 12, and is part of the registry of the POS terminal 1. The stored parameter settings include the font that is used (device font), the print resolution, and the compression method used for transmission. As described above, the parameter settings stored here are updated by the language monitor 121, and default information (values) are used when this process is not executed. Note that the parameter settings storage area 13 could be a hard disk drive, for example.

The printer 2 is a printing device that receives a print request from the POS terminal 1 and prints a receipt, for example. The printing method is typically a thermal transfer or inkjet printing method as used in a typical P OS printer. The parameter settings described above are stored in the storage unit (NVRAM, RAM, for example) of the printer 2, and can be set from the POS terminal 1 or an input device disposed to the printer 2.

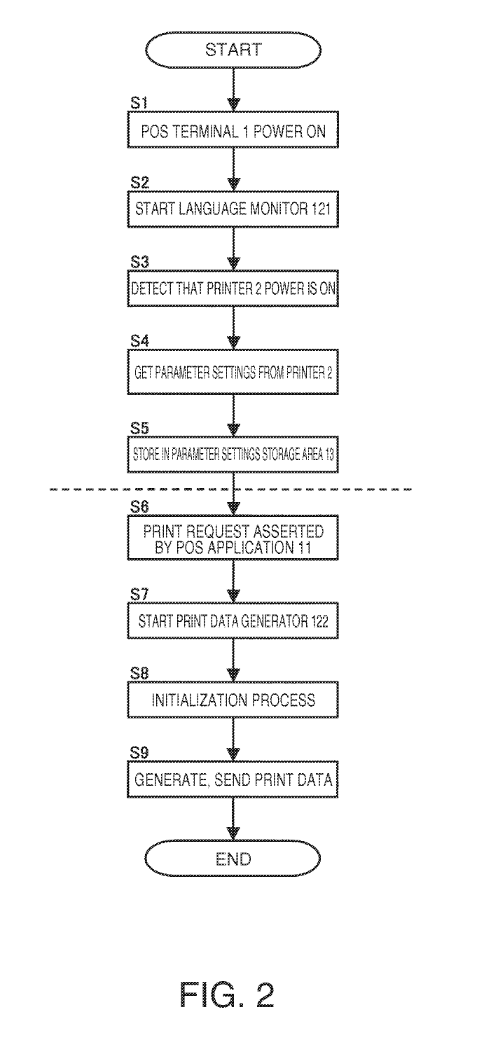

The process executed by the printing system (POS terminal 1 and printer 2) according to the embodiment described above is described below. FIG. 2 is a flow chart of the process. Note that FIG. 2 primarily shows the steps performed by the POS terminal 1.

When the user turns the POS terminal 1 power on (step S1 in FIG. 2), the language monitor 121 is loaded and run by the operating system (or middleware) of the POS terminal 1 (step S2 in FIG. 2).

Once started, the language monitor 121 monitors the status of the printer 2. When the language monitor 121 detects that the printer 2 power turned on (step S3 in FIG. 2), the language monitor 121 runs a process that acquires the parameter settings of the printer 2 (step S4 in FIG. 2). More specifically, using the bidirectional communication function, the language monitor 121 sends a command requesting the parameter settings stored in the printer 2, and acquires the parameter settings by receiving a response from the printer 2 to this command. Note that if the printer 2 power is already on when the language monitor 121 starts, the language monitor 121 detects that the printer 2 is on and immediately acquires the parameter settings.

The language monitor 121 then stores the acquired parameter settings in the parameter settings storage area 13, overwriting (updating) the parameter settings already stored (step S5 in FIG. 2). As a result, the parameter settings (settings information) of the POS terminal 1 and printer 2 are the same. More specifically, the values of parameters such as the device font, resolution, and compression method are the same in the POS terminal 1 and the printer 2.

When a receipt or other print request is received from the POS application 11 (step S6 in FIG. 2), the print data generator 122 is loaded and started by the POS application 11 (step S7 in FIG. 2).

The print data generator 122 is thus initialized and can process information (step S8 in FIG. 2), that is, can read the parameter settings stored in the parameter settings storage area 13 and generate print data.

The print data generator 122 thus receives the print request data from the POS application 11, and the print data generator 122 generates print data based on the acquired request data and the retrieved parameter settings. The generated print data is thus data based on parameter settings that are matched to the printer 2. The print data generator 122 then sends the generated print data to the printer 2 (step S9 in FIG. 2).

The printer 2 receives the print data and runs the printing process based on the data. As a result, the receipt or other printout requested by the P OS application 11 is output.

As described above, the printing system according to this embodiment of the invention runs a printing process after matching the settings of the printer driver 12 and printer 2.

The parameter settings are updated by the language monitor 121 when the printing system starts up (when the P OS terminal 1 and printer 2 power turn on) in the foregoing embodiment, but this process could be timed to when the printing process executes. In this implementation, the language monitor 121 acquires the parameter settings from the printer 2 and updates the information in the parameter settings storage area 13 whenever a print request is received from the P OS application 11. The print data generator 122 then generates and sends the print data based on the updated parameter settings. By changing the timing of this process to the timing described here, settings are updated more frequently, the printing process is always executed using the most recent settings, and a mismatch between the settings of the P OS terminal 1 and printer 2 can be reliably prevented. The process executed at this timing is suited to configurations in which the settings can be changed on the printer 2 side.

Alternatively, the update process could be executed when the printer driver 12 is installed in the POS terminal 1. By executing the update process at this time, the parameter settings of a printer that were customized for the printing system can be automatically copied and set in the printer driver.

If the parameter setting update process is not executed for some reason, the print data is generated using the default values described above. These default values are parameters and settings enabling printing without losing any functionality regardless of the settings on the printer side.

As described above, because the printer driver 12 automatically acquires the parameter settings of the printer 2 and updates the parameter settings of the driver to match when the printing system described in this embodiment of the invention starts operating, the settings of the printer and the printer driver are automatically synchronized, and the need for the user to perform a complicated reconfiguration task is eliminated.

In addition, because content that has been customized for a particular printer installation is automatically reflected on the printer driver side by this automatic parameter setting update function, this printer driver is also compatible with printer drivers having different customized content, and a single printer driver can be used for multiple printers of the same model. The problem of user confusion caused by multiple printer drivers can therefore be eliminated.

Furthermore, by executing the automatic update process before each printing process, a printing process with matching settings on the host side and the printer side can be executed even when there is a strong possibility that a setting was changed on the printer 2 side.

Furthermore, because the print data is generated with the default parameter settings when the automatic update process is not executed, there is no problem with using the printer to print.

While the invention is described using a POS system by way of example, the invention can also be used with other systems in which printer settings are customized.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printing control device that sends print data to and controls printing by a printer, comprising:
a storage unit that stores settings information for generating the print data;
a configuration unit that acquires information set in the printer at a specific time, and stores the acquired information as the settings information in the storage unit; and
a generating unit that generates the print data based on the settings information stored in the storage unit when printing by the printer is requested.

2. The printing control device described in claim 1, wherein:
the specific time is when the printer power turning on is detected.

3. The printing control device described in claim 1, wherein:
the specific time is when printing by the printer is requested.

4. The printing control device described in claim 1, wherein:
the settings information includes at least font information.

5. The printing control device described in claim 1, wherein:
a default value of the settings information is stored in the storage unit.

6. A printing control method of a printing control device that sends print data to and controls printing by a printer, comprising:
acquiring information set in the printer at a specific time, and storing the acquired information as settings information; and
generating the print data based on the stored settings information when printing by the printer is requested.

7. The printing control method described in claim 6, wherein:
the specific time is when the printer power turning on is detected.

8. The printing control method described in claim 6, wherein:
the specific time is when printing by the printer is requested.

9. The printing control method described in claim 6, wherein:
the settings information includes at least font information.

10. The printing control method described in claim 6, wherein:
a default value of the settings information is stored when information set in the printer cannot be acquired.

11. A computer-readable recording medium recording a program causing a control unit of a printing control device to execute the steps of the printing control method described in claim 6.

12. A printing system comprising:
a printer; and
a printing control device that sends print data to and controls printing by the printer;
the printing control device including a storage unit that stores settings information for generating the print data,
a configuration unit that acquires information set in the printer at a specific time, and stores the acquired information as the settings information in the storage unit, and
a generating unit that generates the print data based on the settings information stored in the storage unit when printing by the printer is requested; and
the printer returning the settings information stored in the printer in response to a command requesting the settings information from the printing control device, and printing according to the print data generated by the generating unit of the printing control device based on the settings information.

13. The printing system described in claim 12, wherein:
the specific time is when the printer power turning on is detected.

14. The printing system described in claim 12, wherein:
the specific time is when printing by the printer is requested.

15. The printing system described in claim 12, wherein:
the settings information includes at least font information.

16. The printing system described in claim 12, wherein:
a default value of the settings information is stored in the storage unit.
